(19) United States
(12) Patent Application Publication
(10) Pub. No.: US 2006/0076440 A1
(43) Pub. Date: Apr. 13, 2006

(54) Apparatus for processing organic substances

(75) Inventors: Yong Gu Kim, Seoul (KR); Tae Hee Kwak, Incheon (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/119,891

(22) Filed: May 3, 2005

(30) Foreign Application Priority Data
Oct. 7, 2004 (KR) P2004-80092

(51) Int. Cl. B02C 19/00

(52) U.S. Cl. 241/65

(57) ABSTRACT

The present invention provides an apparatus for processing organic substances, by which performance of processing the organic substances is enhanced. The present invention includes a grinding device for grinding inputted organic substances and a drying device for drying the organic substances grinded by the grinding device.

This application claims the benefit of the Korean Application No. P2004-80092 filed on Oct. 7, 2004, which is hereby incorporated by reference.

### BACKGROUND OF THE INVENTION

1. Field of the Invention

The present invention relates to an apparatus for processing organic substances such as food and the like, by which performance of processing organic substances is enhanced.

2. Discussion of the Related Art

Generally, an organic substance handling apparatus is to process organic substances by reducing weight and volume of the organic substances and is further to restrain the generation of stink, insects and the like to maintain hygienic environment of processing organic substances.

A garbage processing device among the above-functioning organic substance processing apparatuses according to a related art is explained as follows.

The related art garbage processing device is mainly categorized into a heat & dry type and a fermentation type using a microbic biochip.

The heat & dry type garbage processing device is to reduce a volume of garbage in a manner of evaporating moisture of garbage with radiation heat generated from a heat source such as an electrical heater to dry the garbage.

For this, a fan enforcing a flow of air is additionally provided to the heat source such as the electrical heater and the like of the heat & dry type garbage processing device, whereby hot air evaporates moisture of the garbage.

Hence, in the heat & dry type garbage processing device, the evaporated moisture is discharged outside by the driven fan to process the garbage and to reduce a volume of the garbage.

However, the related art heat & dry type garbage processing device has the following problems.

First of all, the related art heat & dry type garbage processing device processes the garbage using high-temperature radiation heat and hot air, whereby the garbage processing takes a considerable time to lower garbage processing performance.

Secondly, the related art heat & dry type garbage processing device needs to drive the electrical heater and the fan for a considerably long time to process the garbage, whereby the maintenance cost according to power consumption is raised.

Thirdly, the related art fermentation type garbage processing device needs to keep being replenished with biochips, whereby the maintenance cost is raised and whereby the garbage processing takes a considerable time to lower garbage processing performance.

### SUMMARY OF THE INVENTION

Accordingly, the present invention is directed to an apparatus for processing organic substances that substantially obviates one or more problems due to limitations and disadvantages of the related art.

An object of the present invention is to provide an apparatus for processing organic substances such as food and the like, by which time and costs for processing the organic substances are reduced to enhance performance of processing the organic substances.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for processing organic substances according to the present invention includes a grinding device for grinding inputted organic substances and a drying device for drying the organic substances grinded by the grinding device.

Preferably, the grinding device includes a housing having an organic substance input portion and a grinding part provided within the housing to grind the organic substances inputted via the organic substance input portion.

More preferably, the grinding part includes a rotation grinder rotatably provided to grind the organic substances.

More preferably, the rotation grinder includes a first rotational body rotatably provided and a second rotational body rotatably provided to one side of the first rotational body to grind the organic substances together with the first rotational body.

More preferably, at least one thread is provided to at least one of the first and second rotational bodies.

More preferably, the second rotational body is rotated in a direction reverse to a rotational direction of the first rotational body.

More preferably, at least one first thread having a prescribed lead angle is provided to the first rotational body and at least one second thread is provided to the second rotational body 222 to engage with the first thread.

More preferably, the grinding device further includes a transport part transporting the organic substances inputted via the organic substance input portion to the rotation grinder.

More preferably, the transport part includes a body rotatably provided and at least one transport protrusion provided to an outer circumference of the body in a helical direction.

More preferably, the body is built in one body of the rotation grinder.

Preferably, the drying device includes a drying container storing the organic substances grinded by the grinding device and a heating part supplying heat to an inside of the drying container.

More preferably, the heating part includes a heater provided to a sidewall of the drying container.

More preferably, the drying device further includes an agitator provided within the drying container.

More preferably, the drying device further includes a water discharge portion connected to the drying container to discharge water separated from the grinded organic substances.

More preferably, the drying container further includes a water separating part provided between the agitator and the water discharge portion to separate the water from the grinded organic substances.

More preferably, the water separating part includes a filter enabling water communications.

More preferably, the drying container includes a gas discharge portion discharging gas generated from the grinded organic substances.

More preferably, the drying device further includes a gas discharge pipe connected to the gas discharge portion to discharge the gas.

More preferably, the drying device further includes a blower fan provided to the gas discharge pipe to enforce a discharge of the gas.

More preferably, the drying device further includes a deodorizing part provided to one side of either the drying container or the gas discharge pipe to remove stink of the gas.

Therefore, by the above-configured apparatus for processing the organic substances, time and costs for processing the organic substances are reduced and the performance of processing the organic substances is enhanced.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional diagram of an apparatus for processing organic substances according to one embodiment of the present invention;

FIG. 2 is a layout of a water separating filter provided to the apparatus shown in FIG. 1;

FIG. 3 is a horizontal cross-sectional diagram of a grinding device, which is bisected along a cutting line I-I, provided to the apparatus shown in FIG. 1; and

FIG. 4 is a perspective diagram of a grinding part and a transport part provided to the grinding device shown in FIG. 3.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

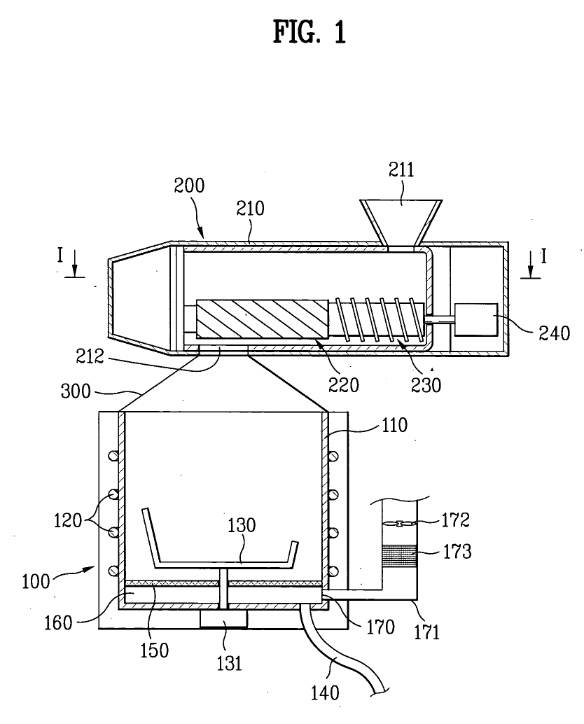

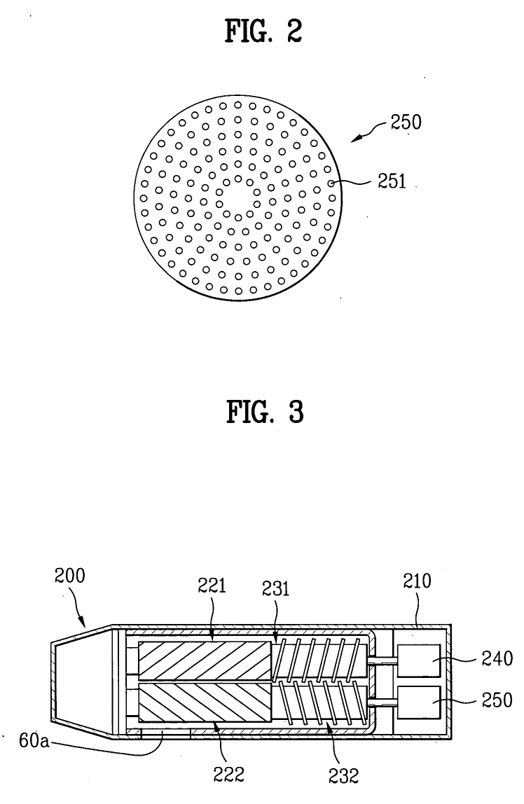

First of all, an apparatus for processing organic substances according to one embodiment of the present invention is explained with reference to FIG. 1 and FIG. 2 as follows.

The apparatus for processing the organic substances is an apparatus for processing organic substances including garbage and the like by a heat & dry method, and more particularly, an organic substance processing apparatus that processes organic substances in a manner of grinding the organic substances inputted thereto into small sized particles and drying the grinded organic substances.

Referring to FIG. 1, an apparatus for processing organic substances includes a drying device 100 removing moisture of the organic substances and a grinding device 200 provided to one side of the drying device 100 to grind the inputted organic substances.

The drying device 100 includes a drying container 110 storing the organic substances grinded by the grinding device 200 and a heating part providing heat to an inside of the drying container 110.

In the present embodiment, the drying container 110 has a cylindrical shape and can be also modified to have various shapes.

The grinding device 200 is provided on the drying container 110. An upper end of the drying container 110 and the grinding device 200 are connected to each other via a connecting pipe 300 having a prescribed shape.

The connecting pipe 300 has a funnel shape of which diameter increases downward or one of various shapes such as a cylinder and the like.

And, the heating part is provided to a sidewall of the drying container 110. Specifically, the heating part includes an electric heater 120 that is wound up on an outer circumference of the drying container 110 to adhere closely to the outer circumference of the drying container 110 and to generate heat by power supply. Alternatively, the heating part is not limited to the electric heater 120.

Within the drying container 110, an agitator 130 agitating the organic substances evenly is provided to dry the grinded organic substances efficiently by the heat generated from the electric heater 120.

The agitator 130, which is connected to an agitator motor 231 provided under the drying container 110, is rotated to agitate the organic substances stored in the drying container 110.

Namely, the agitator 130 is preferably configured to be rotated by the driven electric heater 120 in the process of drying the grinded organic substances received in the drying container 110.

Alternatively, an agitator (not shown in the drawing), which agitates the organic substances by vibration, can be provided within the drying container 110.

And, a water discharge part 140 is preferably connected to a bottom of the drying container 110 to discharge water separated from the grinded organic substances.

It is a matter of course that the moisture involved in the grinded organic substances received in the drying container 110 is evaporated as steam to be discharged outside.

Yet, a liquid portion of the moisture involved in the grinded organic substances received in the drying container 110 is discharged via the water discharge part 140 and the rest portion is evaporated into steam by the heating part. And, such a system shortens a drying time of the organic substances.

A water separating part 150 is preferably provided to a location having a prescribed height from the bottom of the drying container 110 to separate moisture, i.e., water from the grinded organic substances.

The water separating part 150, as shown in FIG. 2, includes a filter, which enables water communications, having a multitude of perforated holes 151, and more particularly, microscopic perforated holes. Alternatively, the water separating part 150 is not limited to such a filter.

The water separating part 150 is provided under the agitator 130, and a water receiving space 160 having a prescribed volume is formed between the bottom of the drying container 110 and the water separating part 150.

A gas discharge portion 170 is provided t one side of the drying container 110. Hence, gas generated from the grinded organic substances, i.e., gas including the steam evaporated by the electric heater 120 is discharged via the gas discharge portion 170.

Preferably, the gas discharge portion 170 is configured to penetrate one sidewall of the water receiving space 160.

This is because the gas discharge portion 170 can be blocked by the grinded organic substances in case that the gas discharge portion 170 is provided to a sidewall of an upper space over the water separating part 150.

And, a gas discharge pipe 171 is connected to the gas discharge portion 170 to guide the gas outside.

Preferably, a blower fan 172 enforcing an airflow and a deodorizing part 173 deodorizing stink involved in the gas are provided to the gas discharge pipe 171.

Alternatively, the deodorizing part 173 can be provided to the drying container 110, and more particularly, to the gas discharge portion 170.

The stink deodorization by the deodorizing part 173 can be performed by one of various systems such as heat exchange, contact oxidation, adsorption, combustion, etc.

Meanwhile, the grinding device 200 includes a housing 210 having an organic substance input portion 211 and an organic substance discharge portion 212 and a grinding part provided within the housing 210 to grind the organic substances.

The organic substance input portion 211 is preferably configured to have a hopper shape formed at one upper side of the housing 210, and the organic substance discharge portion 212 is connected to an upper end of the connecting pipe 300.

And, the grinding part includes a rotation grinder 220 rotating to grind the organic substances inputted via the organic substance input portion 211.

Moreover, a transport part 230 is preferably provided within the housing 210 to transport the organic substances inputted via the organic substance input portion 211 to the rotation grinder 220.

In this case, the rotation grinder 220 is configured to be rotated by a grinding motor 240.

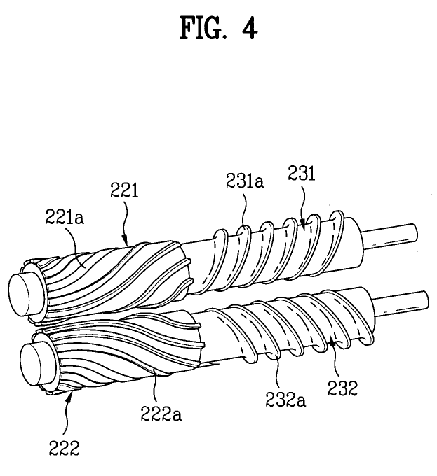

The rotation grinder 220 and the transport part 230 provided to the grinding device 200 are explained with reference to FIG. 3 and FIG. 4 as follows.

FIG. 3 is a horizontal cross-sectional diagram of a grinding device, which is bisected along a cutting line I-I, provided to the apparatus shown in FIG. 1 and FIG. 4 is a perspective diagram of a grinding part and a transport part provided to the grinding device shown in FIG. 3.

The rotation grinder 220 includes a first rotational body 221 rotated by the grinding motor 240 and a second rotational body 222 rotatably provided to one side of the first rotational body 221 to grind the organic substances together with the first rotational body 221.

Preferably, to smoothly grind the organic substances inputted to the housing 210 into small pieces, at least one thread is provided to at least one outer circumference of the first and second rotational bodies 221 and 222.

In the present embodiment, the first and second rotational bodies 221 and 222 are provided to turn in opposite directions, respectively so that the organic substances pass between the first and second rotational bodies 221 and 222 to be grinded.

For this, at least one first thread 221a having a prescribed lead angle is provided to the outer circumference of the first rotational body 221 and at least one second thread 222a is provided to the outer circumference of the second rotational body 222 to engage with the first thread 221a.

More preferably, a plurality of threads are provided to each of the first and second rotational bodies 221 and 222. The first and second rotational bodies 221 and 222 are provided parallel to each other so that the organic substances transported by the transport part 230 can be distributed to the entire area of an engaging portion between the first and second rotational bodies 221 and 222 to be grinded.

In this case, the second rotational body 222 can be configured to be rotated by the first rotational body 221. To enhance power of grinding the organic substances, the second rotational body 222 is preferably configured to be rotated by an auxiliary grinding motor 250.

Alternatively, the first and second rotational bodies 221 and 222 can be configured to rotate in the same direction. And, the thread provided to the outer circumference of the first rotational body 221 may not engage with the other thread provided to the outer circumference of the second rotational body 222. Yet, if so, performance of grinding the organic substances is somewhat lowered.

And, sharp cutting edges can be provided to ridges of the first and second threads 221a and 222a to pulverize the organic substances by a cutting system.

In this case, the at least one first thread 221a provided to the outer circumference of the first rotational body 221 is formed long in a helical direction from one end to the other end of the first rotation body 221. And, the at least one second thread 222a provided to the outer circumference of the second rotational body 222 is formed long in a helical direction from one end to the other end of the second rotation body 222.

Optionally, a multitude of gears, which engage with each other to rotate, are provided to the first and second rotational bodies 221 and 222 to pulverize or grind the organic substances.

The transport part 230 includes a body rotatably provided under the organic substance input portion 211 and at least one transport protrusion provided to an outer circumference of the body in a helical direction.

Specifically, the transport part 230 includes a first body 231 built in one body of the first rotational body 221, at least one first transport protrusion 231a provided to an outer circumference of the first body 231 in a helical direction, a second body 232 built in one body of the second rotational body 222, and at least one first transport protrusion 232a provided to an outer circumference of the second body 232 in a helical direction.

In this case, one end of the second body 232 is connected to a rotational shaft of the auxiliary grinding motor 250 and the other end of the second body 232 is connected in one body to the second rotational body 222.

By the above configuration, the organic substances inputted via the organic substance input portion 211 are divided into small portions to be transported toward the rotation grinder 220. And, the organic substances can be grinded in part by the transport part 230 in the process of being transported by the transport part 230.

An operation of the organic substance processing apparatus according to the present invention is explained as follows.

First of all, organic substances such as garbage are inputted to the housing 210 via the organic substance input portion 211. The garbage inputted to the housing 210 then falls down to the transport part 230.

The garbage having fallen down to the transport part 230 is distributed into prescribed quantities by the first transport protrusion 231a provided to the outer circumference of the first body 231 rotated by the grinding motor 240 and the second transport protrusion 232a provided to the outer circumference of the second body 232 rotated by the auxiliary grinding motor 250 to be transported toward the rotation grinder 220.

The garbage having been transported to the rotation grinder 220 is grinded by the first rotational body 221 rotated in one body with the first body 231 and the second rotational body 222 rotated in one body with the second body 232 and is then discharged via the organic substance discharge portion 212.

Specifically, the garbage having been transported to the rotation grinder 220 is grinded into small particles by the first thread 221a of the first rotational body and the second thread 222a of the second rotational body engaging with the first thread 221a to rotate.

The garbage, which was grinded by the grinding device 200 and its discharged via the organic substance discharge portion 212, is inputted to the drying container 110 via the connecting pipe 300 to undergo a moisture separating process.

Specifically, once the garbage grinded into the small particles is inputted to the drying container 110, the electric heater 120 and the agitator 130 are actuated.

In this case, the agitator 130 plays a role in agitating the garbage evenly to enable the garbage within the drying container 110 to be dried within a short time by the electric heater 120.

While the garbage drying process is carried out, the moisture of the garbage, i.e., water is separated by the water separating part 150 to be discharged outside via the water discharge part 140.

And, the steam generated from the evaporation by the actuation of the electric heater 120 and the agitator 130, i.e., the gas is discharged outside by the actuation of the blower fan 172 via the gas discharge pipe 171.

In doing so, since the stink of the gas is removed by the deodorizing part 173 in the process of passing through the gas discharge pipe 171, a user does not fell unpleasantness.

Accordingly, the above-configured apparatus for processing the organic substances according to the present invention has the following effects or advantages.

First of all, the organic substance processing apparatus according to the present invention is provided with the grinding device for grinding the organic substances into small particles prior to removing the moisture from the organic substances, thereby reducing the drying time of the organic substances, i.e., the processing time of the organic substances and to enhance organic substance processing performance.

Secondly, the organic substance processing apparatus according to the present invention is provided with the agitator evenly agitating the organic substances to dry the grinded or pulverized organic substances in a short time, thereby shortening the organic substance processing time.

Thirdly, the organic substance processing apparatus according to the present invention is provided with the grinding device employing a screw system to transport/grind the organic substances, whereby the inputted organic substances are evenly distributed for transport and grinding. Hence, the organic substance grinding time is shortened, the grinded particle size is uniform, and the performance of drying the organic substances is enhanced.

Fourthly, the organic substance processing apparatus according to the present invention reduces the time of drying the organic substances, thereby decreasing power consumption needed to dry the organic substances.

Fifthly, the organic substance processing apparatus according to the present invention enhances the performance of removing the moisture from the organic substances, thereby reducing the weight of the organic substances smoothly.

Finally, the organic substance processing apparatus according to the present invention is provided with the deodorizing part for deodorizing the stink involved in the organic substances, thereby providing hygienic and pleasant environment to a user.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for processing organic substances, comprising:
a grinding device for grinding inputted organic substances; and
a drying device for drying the organic substances grinded by the grinding device.

2. The apparatus of claim 1, the grinding device comprising:
a housing having an organic substance input portion; and
a grinding part provided within the housing to grind the organic substances inputted via the organic substance input portion.

3. The apparatus of claim 2, the grinding part comprising a rotation grinder rotatably provided to grind the organic substances.

4. The apparatus of claim 3, the rotation grinder comprising;
a first rotational body rotatably provided; and
a second rotational body rotatably provided to one side of the first rotational body to grind the organic substances together with the first rotational body.

5. The apparatus of claim 4, wherein at least one thread is provided to at least one of the first and second rotational bodies.

6. The apparatus of claim 4, wherein the second rotational body is rotated in a direction reverse to a rotational direction of the first rotational body.

7. The apparatus of claim 6, wherein at least one first thread having a prescribed lead angle is provided to the first rotational body and wherein at least one second thread is provided to the second rotational body 222 to engage with the first thread.

8. The apparatus of claim 3, the grinding device further comprising a transport part transporting the organic substances inputted via the organic substance input portion to the rotation grinder.

9. The apparatus of claim 8, the transport part comprising:
a body rotatably provided; and
at least one transport protrusion provided to an outer circumference of the body in a helical direction.

10. The apparatus of claim 9, wherein the body is built in one body of the rotation grinder.

11. The apparatus of claim 1, the drying device comprising:
a drying container storing the organic substances grinded by the grinding device; and
a heating part supplying heat to an inside of the drying container.

12. The apparatus of claim 11, the heating part comprising a heater provided to a sidewall of the drying container.

13. The apparatus of claim 11, the drying device further comprising an agitator provided within the drying container.

14. The apparatus of claim 11, the drying device further comprising a water discharge portion connected to the drying container to discharge water separated from the grinded organic substances.

15. The apparatus of claim 14, the drying container further comprising a water separating part provided between the agitator and the water discharge portion to separate the water from the grinded organic substances.

16. The apparatus of claim 15, the water separating part comprising a filter enabling water communications.

17. The apparatus of claim 11, the drying container comprising a gas discharge portion discharging gas generated from the grinded organic substances.

18. The apparatus of claim 17, the drying device further comprising a gas discharge pipe connected to the gas discharge portion to discharge the gas.

19. The apparatus of claim 18, the drying device further comprising a blower fan provided to the gas discharge pipe to enforce a discharge of the gas.

20. The apparatus of claim 18, the drying device further comprising a deodorizing part provided to one side of either the drying container or the gas discharge pipe to remove stink of the gas.
